(19) United States
(12) Patent Application Publication
(10) Pub. No.: US 2013/0330499 A1
(43) Pub. Date: Dec. 12, 2013

(54) Multi-layer Plastic Film and Film-coated Compression-molded Component

(71) Applicants: Hans Rudolf Czerny, Swisttal (DE); Michael Hisserich, Huckeswagen (DE); Andreas Sviridenko, Dormagen (DE)

(72) Inventors: Hans Rudolf Czerny, Swisttal (DE); Michael Hisserich, Huckeswagen (DE); Andreas Sviridenko, Dormagen (DE)

(73) Assignee: CARCOUSTICS TECHCONSULT GMBH, Leverkusen (DE)

(21) Appl. No.: 13/884,373

(22) PCT Filed: Nov. 9, 2011
(86) PCT No.: PCT/EP2011/069776

§ 371 Date: Jul. 1, 2013

(30) Foreign Application Priority Data
Nov. 9, 2010 (DE) 10 2010 060 442.9

(51) Int. Cl. B32B 27/08; B29C 43/20

(52) U.S. Cl. CPC B32B 27/08; B29C 43/203
USPC 428/76; 156/331.7; 264/265; 428/212

(57) ABSTRACT

The invention relates to a multi-layer plastic film (1, 1′, 1″) for coating components manufactured by compression molding. The film comprises at least a first layer (2, 2′, 2″) consisting of a first plastic material and a second layer (4, 4′, 4″) consisting of a second plastic material. Furthermore, the first plastic material has a higher temperature resistance than the second plastic material, with the second plastic material being thermoplastic.

### FIELD

The present disclosure relates to a multi-layer plastic film. Furthermore, the subject matter of the disclosure is a film-coated compression-molded component, a method for producing such a component and the use of such a component for thermal and/or sound insulation in motor vehicles. Within the context of the disclosure, compression molding is to be understood to be a method for material processing with which a permanent 3D shape is given under the influence of heat and pressure to a generally two-dimensionally extending, plane workpiece. In addition to the shape of the cavity used for compression, the process temperature and the pressure applied, in particular the retention time of the workpiece in the cavity of the pressing machine is in this case a particularly relevant process parameter. Materials particularly suited for compression molding include, for example, non-woven fabrics or foamed duroplastic plastics impregnated with a thermosetting resin or binder.

### BACKGROUND

Multi-layer plastic films are known from the state of the art in a great variety. Apart from the use of the multi-layer plastic films in the packaging industry, they are especially used for covering, for example, thermally and/or acoustically active insulating layers or components with a skin. The plastic films protect the insulating layers against damage that can be caused by external influences such as temperature and moisture. For example, the use of a duplo film consisting of an elasticized polyester and a ester urethane film for covering acoustically active compression-molded components consisting of a resin-impregnated non-woven cotton fabric with a skin is known, wherein the film is produced by means of co-extrusion. However, a disadvantage of this film is its low temperature resistance. If this film is used for covering with a skin during a compression molding process, the compression molding process can only take place in a relatively low temperature range. Thus, production is time-consuming. Furthermore, the duplo film used is very susceptible to hydrolysis.

Furthermore, multi-layer plastic films for covering insulating layers with a skin, which comprise on one side a film with a relatively high softening point and on the other side a film with a relatively low softening point, are known from DE 2935631 A1. The films are co-extruded under the influence of heat and pressure. These multi-layer plastic films are used, among other things, for covering compression-molded foamed plastics or resin-reinforced non-woven fabrics with a skin. During compression molding, these multi-layer plastic films are exposed to strong shearing forces and in the process tend to delaminate. The protection of the skin-covered foamed plastics or non-woven fabrics against external influences can thus no longer be ensured. Since delamination is not visible from the outside, there is a danger of the manufactured components being installed in, for example, motor vehicles even though they are faulty. A component failure in that case occurs while the motor vehicle is being used, which incurs high costs, for example due to replacement.

### SUMMARY

Therefore, the disclosure is directed to proposing a multi-layer plastic film for covering a compression-molded component with a skin, the film having an improved temperature resistance and molding capability. Further proposed is a film-coated compression-molded component with an improved durability and a suitable manufacturing process.

This is accomplished by a multi-layer plastic film having the features of claim 1, a film-coated compression-molded component having the features of claim 10 and a method for producing a film-coated compression-molded component having the features of claim 15. Advantageous embodiments are in each case the subject matter of the dependent claims. It must be remarked that the features cited individually in the patent claims, even across the different categories of the claims, can be combined in any technologically meaningful manner and present other embodiments of the disclosure.

A multi-layer plastic film according to the disclosure for coating components manufactured by compression molding comprises at least a first layer consisting of a first plastic material and a second layer consisting of a second plastic material. In this case, the first plastic material of the present disclosure has a higher temperature resistance than the second plastic material, which is a thermoplastic material. Furthermore, an adhesion layer is disposed between the first and the second layers, which mechanically bonds the first to the second layer.

The multi-layer plastic film according to the disclosure is advantageous in that the provided adhesion layer is able to absorb the shearing forces during the compression molding process, so that shearing-induced damage to the film, as it is frequently observed during the use of the co-extruded films known from DE 2935631 A1 for covering compression-molded components with a skin, is avoided virtually entirely.

The film-coated compression-molded component according to the present disclosure has a generally two-dimensionally extending insulating layer which is coated at least on one side with a multi-layer plastic film according to the disclosure. The second layer of the multi-layer plastic film in this case faces towards the insulating layer. The multi-layer plastic film and the insulating layer are mechanically firmly bonded to each other by temporarily melting on the thermoplastic second layer.

Furthermore, the subject matter of the disclosure is a method for producing a film-coated compression-molded component. In a first step, a multi-layer plastic film according to the disclosure is provided in the process. In the subsequent step, a generally two-dimensionally extending, compression-moldable and thermally and/or acoustically active insulating layer is provided. Then, the insulating layer is covered with the multi-layer plastic film at least on one side. Then, the film-covered insulating layer is compression-molded. During the compression molding process, the film-covered insulating layer, on the one hand, obtains the shape determined by the pressing mold. On the other hand, the multi-layer plastic film or multi-layer plastic films and the insulating layer bond to each other by melting on the second layer of the multi-layer plastic film. The multi-layer plastic film and the insulating layer can now no longer be non-destructively detached from one another.

Furthermore, the subject matter of the disclosure is the use of a film-coated compression-molded component according to the disclosure for thermal and/or sound insulation in motor vehicles. The use in the form of engine hood linings, end walls between engine compartments and passenger compartments, insulation of exhaust systems or exhaust units as well as linings of oil pans or transmission tunnels, has proved to be particularly advantageous.

In an advantageous embodiment, the modulus of elasticity of the adhesion layer is smaller than the modulus of elasticity of the first and/or of the second layer. Due to the adhesion layer used here, it is made possible that tensions between the first and the second layer, in particular those tensions that are created during compression molding, can be compensated by the adhesion layer, whereby the molding capability of the multi-layer plastic film according to the disclosure is improved.

In order to obtain as good an adhesion as possible between the first and the second layer of the multi-layer plastic film, the adhesion layer should advantageously have a thickness of between about 1 μm and 15 μm, preferably between about 4 μm to 7 μm.

In one exemplary embodiment, the adhesion layer is formed by means of a primer layer. A primer layer is to be understood to be an adhesion-promoting layer which is preferably applied onto a layer of the film during the production of the multi-layer plastic film according to the disclosure, and which promotes a very good adhesion of this layer to the other layer. According to an advantageous embodiment of the film, the primer layer can be flexible and consist of a cross-linking polymer, particularly preferably of a polyurethane-based cross-linking polymer.

The multi-layer plastic film can be produced in a continuous process. To this end, the first and the second layers are produced in separate extrusion processes, in particular at the same time. The finished extruded layers are guided parallel to and spaced from each other by means of guides. In order to bond the individual layers to each other, an adhesive or primer for forming the adhesion layer is applied onto the inner face of at least one layer. The application of the adhesive or primer can take place by spraying or also manually. Particularly preferably, the adhesive or primer is knife-coated onto a layer.

After the adhesive or primer has been applied, the individual layers are mechanically brought into contact with each other. A solid composite is produced whose adhesion can yet be improved by rolling it down.

An adhesion of the layer can be improved further still by subjecting one of the two layers of the film to a corona treatment prior to the application of the adhesive or primer or prior to bringing it into contact with the adhesive-coated or primer-coated further layer. Such a pre-treatment has proved to be particularly effective in the case of a layer consisting of polyurethane ether.

The finished multi-layer plastic film can either be rolled up or cut into sections of predetermined sizes by means of cutting devices. In principle, there is also the possibility of producing the individual layers of the multi-layer plastic film independently of one another and store them separate from one another. The layers can then be bonded to one another at a later point in time using a suitable adhesive or primer.

The thermoplastic second layer of the multi-layer plastic film, which has a lower level of temperature resistance, is preferably formed from polyurethane ether. Polyurethane ether has a very high hydrolysis resistance. However, the thermoplastic synthetic material can also be selected depending on how and from which materials the insulating layer are built that are to be covered with a skin by means of the multi-layer plastic films according to the disclosure. The selection is to be made in such a way that a good mechanical and chemical compatibility is provided between the multi-layer plastic film, in this case particularly the second layer, and the insulating layer to be covered with a skin. Depending on the insulating layer used, an optimum mechanical bond between the multi-layer plastic film and the insulating layer can alternatively also be obtained by the second layer comprising co-polyamide, co-polyester or co-polyterephthalate.

In an advantageous embodiment, the first layer comprises polyamide 6.6 or consists of this material. Polyamide 6.6 has a high level of mechanical strength, a very good chemical stability and a high melting temperature. It is therefore very suitable for covering components with a skin that are used in areas in which, among other things, high temperatures prevail and in which water-containing or oil-containing and/or aggressive media can be found, for example in engine compartments.

However, it is also conceivable that the first layer consists of a modified polyester or a homopolyamide.

In one embodiment, both the first as well as the second layer of the multi-layer plastic film have a thickness of at least about 10 μm and at most about 35 μm. In an exemplary embodiment, the thickness of the first and the second layer is at least about 15 μm and at most about 25 μm. By using first and second layers with different thicknesses, the acoustic properties of the multi-layer plastic film or of the film-coated compression-molded component can be individually adapted to the particular application.

In another advantageous embodiment, a two-dimensionally extending insulating layer can be covered by a multi-layer plastic film according to the disclosure on both sides. However, it is also conceivable that this is not a two-dimensionally extending, but a three-dimensionally extending film-coated compression-molded component. In order to protect the insulating layer against external influences in this case, the insulating layer has to be covered with the multi-layer plastic film on all sides. A complete encapsulation of the insulating layer is thus accomplished. The component is now particularly resistant against external influences, such as exposure to high temperatures and aggressive substances, and therefore has a longer lifetime. Due to their very high level of hydrolysis resistance, these (2D or 3D) components with a completely encapsulated insulating layer are particularly suitable for use in regions with a high air humidity, such as, for example, the tropics.

It is conceivable that the insulating layer of the film-coated compression-molded component consists of a foamed plastic, e.g. of polyurethane foam. Furthermore, the insulating layer can also consist of a melamine resin foam, such as, for example, of Basotect® by BASF.

In another advantageous embodiment of the disclosure, the insulating layer can also comprise textile non-wovens or textile fabrics. Non-woven cotton fabrics are in this case used with particular preference. By using non-woven cotton fabric, particularly the sound-insulating properties can be improved. The non-woven cotton fabric used can be, for example, torn scraps of cloth.

However, the configuration of the insulating layer is not limited to the above statements. Virtually all compression-moldable materials with advantageous thermal and/or acoustic properties can be used to form the insulating layer.

In an exemplary embodiment of the disclosure, the insulating layer comprises a thermosetting resin or a thermosetting binder; in particular, the insulating layer is impregnated with such a resin or binder. Phenolic resins, for example, have proved to be particularly suitable. Phenolic resins set at temperatures of about 150° C. to 170° C. and are unbreakable after curing and, as a thermosetting material, resistant to high temperatures. Melamine resins have similarly advantageous properties. Both resins are preferably introduced into the insulating layer in a powdery form. The resins cross-link during compression molding and develop properties of a thermosetting material that are accompanied by, for example, a high level of temperature resistance.

The temperature during compression molding has to be selected so as to be at least so high that, on the one hand, the softening point of the second layer of the multi-layer plastic film is reached. Thus, the thermoplastic second layer can act as a melt adhesive, and a substance-to-substance bond between the multi-layer plastic film and the insulating layer is created that has a high mechanical strength. On the other hand, the temperature during compression molding has to be selected to be at least so high that, if a resin or binder is present in the insulating layer, the curing reaction of the resin or binder can take place.

In an exemplary embodiment of the disclosure, the compression molding process of the film-coated component takes place at a temperature of more than 180° C., preferably more than 200° C., particularly preferably more than 220° C. This enables a relevant shortening of the compression molding cycle and thus a reduction of the cycle time. This is accompanied by a considerable reduction of the production cost of the components.

In one embodiment of the present disclosure, the duration of the compression process is less than 100 seconds, preferably less than 90 second, particularly preferably less than 70 seconds.

In an advantageous embodiment, the film-coated compression-molded component is used as an acoustically active engine hood lining or as an acoustically active dividing wall between the passenger compartment and the engine compartment. Furthermore, the film-coated compression-molded components according to the present disclosure are very suitable as end walls as well as linings of transmission tunnels and oil pans. However, it is also conceivable that the component is used for the thermal and/or acoustic insulation of buildings or pipelines.

The disclosure as well as the technical environment are explained in more detail below with reference to the figures. It must be remarked that the Figures depict an exemplary embodiment of the invention. However, the invention is not limited to the embodiment shown. In particular, the invention, insofar as is technically feasible, includes any combinations of the technical features that are put forth in the dependent claims or are described as being relevant to the disclosure in the description.

### BRIEF DESCRIPTION OF THE FIGURES

In the Figures:

FIG. 1: shows a schematic sectional view of a multi-layer plastic film in an embodiment;

FIG. 2: shows a schematic sectional view of a two-dimensionally extending film-coated compression-molded component in an embodiment.

### DETAILED DESCRIPTION

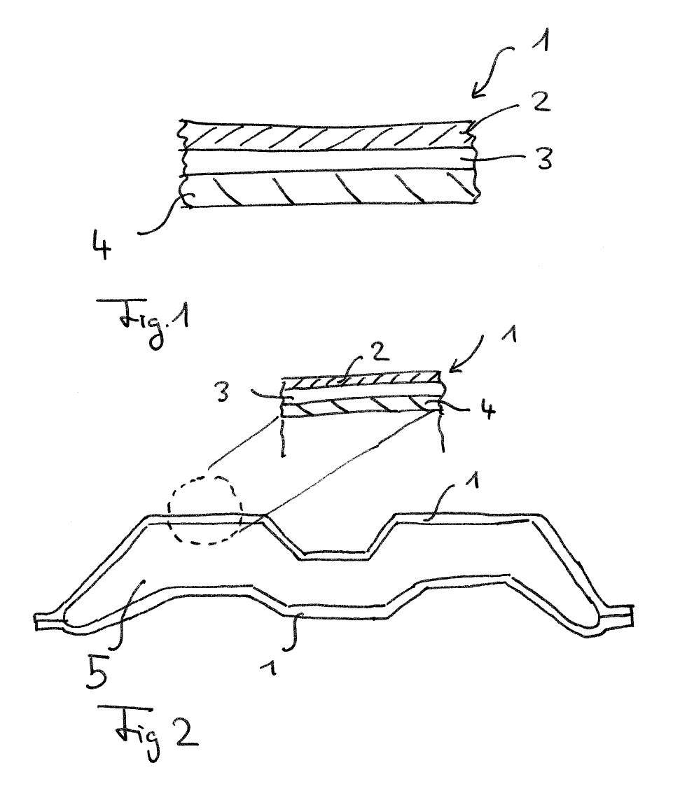

The multi-layer plastic film 1 shown in FIG. 1 consists of a first layer 2, a thermoplastic second layer 4 and an adhesion layer 3 disposed between the first layer 2 and the second layer 4. The adhesion layer 3 is formed by a flexible primer layer with a thickness of a few μm; preferably, it has a thickness of about 4 μm to 7 μm. A cross-linking polymer that has an increased adhesion both on the first layer 2 and on the second layer 4 is used as the primer.

The second layer 4 advantageously consists of a thermoplastic polyurethane that softens at an increased temperature. Thus, the second layer 4 has adhesive properties at increased temperatures and is therefore very suitable as a hot-melt adhesive. Polyurethane ether has proved to be a particularly suitable material for the second layer.

The first layer 2 consists, for example, of polyamide 6.6.

The first layer 2 and the second layer 4 each have a thickness of about 15 μm to 35 μm. However, the first layer 2 and the second layer 4 can also differ with regard to their thickness.

In order to produce the film composite, films of polyamide for forming the first layer 2 and of polyurethane for forming the second layer 4 are extruded separately. Then, a primer layer of a defined thickness is applied, preferably knife-coated, onto one side of the polyurethane film or of the polyamide film. Optionally, the adhesion of the primer layer on the polyurethane film can be improved even more by a prior corona treatment of the surface of the polyurethane film. After the application of the primer layer, the polyamide film and the polyurethane film are brought together, enclosing the primer layer, and brought into mechanical contact, the result being the polyamide film and the polyurethane film being glued together over their surfaces. The strength of this film composite can be increased by a local application of force onto the film composite, for example by the composite being guided through one or more roller pairs. Then, the film composite is reeled up on a coil and stored in a reeled-up form for later use.

FIG. 2 schematically shows a section through a two-dimensionally extending film-coated compression-molded component 6, which can be, for example, an engine hood insulation. The component 6 comprises an insulating layer 5 coated on both sides by a multi-layer plastic film 1′, 1″. Each of the multi-layer plastic films 1′, 1″ is bonded to the insulating layer 5 in a substance-to-substance bond. Furthermore, the multi-layer plastic films 1′, 1″ are peripherally directly bonded to one another in a substance-to-substance bond on the edges. Thus, the insulating layer 5 is completely enclosed by the multi-layer plastic films 1′, 1″ so that the insulating layer 5 is completely encapsulated and therefore effectively protected against environmental influences.

Both multi-layer plastic films 1′, 1″ consists of a first layer 2′, 2″, a second layer 4′, 4″ and an interposed adhesion layer 3; their structure thus corresponds to the structure of the multi-layer plastic film 1 shown in FIG. 1.

The insulating layer 5 consists of a non-woven cotton fabric impregnated with a non-curing phenolic resin. Non-woven cotton fabrics are particularly suitable in the field of automotive engineering because they have good sound-insulation properties at low material costs.

The component from FIG. 2 is produced by compression molding in a heated molding tool. To this end, a pre-cut section of the pre-assembled multi-layer plastic film 1″, a pre-cut section of the insulating layer 5 and a pre-cut section of the multi-layer plastic film 1′ are laid horizontally one on top of the other, so that the first layers 2′, 2″ of the multi-layer plastic films 1′, 1″ are oriented outwards. In this case, the sections of the multi-layer plastic films 1′, 1″ are dimensioned to be slightly bigger than the section of the insulating layer 5, so that the multilayer plastic films 1′, 1″ reach over the edges of the insulating layer 5 on all sides. The loose composite thus created is gripped by means of a suitable tool on two opposing long sides, thus mechanically fixed, and laid into the heated opened molding tool attached to a pressing machine, whereupon the molding tool is closed.

The component produced obtains the shape predetermined by the tool due to the pressure of the pressing machine onto the molding tool. The halves of the molding tool are heated to up to 240° C., so that the phenolic resin in the insulating layer cures during the compression molding process. Since the PA 6.6 used for the first layers 2′, 2″ of the multi-layer plastic films 1′, 1″ has a very high level of temperature resistance, high temperatures of the molding tool can be employed which results in a short curing time of the insulating layer impregnated with phenolic resin. Thus, the cycle time can be shortened, which is accompanied by a significant efficiency increase of the manufacturing process.

Moreover, the second layers 4′, 4″ adjacent to the insulating layer 5 melt on and thus act as a melt adhesive. A non-detachable bond between the insulating layer 5 and the multi-layer plastic films 1′, 1″ is produced.

The part of the multi-layer plastic films 1′, 1″ extending over the edges of the insulating layer 5 is directly welded together during the compression molding process and thus completely seals the insulating layer 5 towards the outside.

1.-20. (canceled)

21. A multi-layer plastic film for coating components manufactured by compression molding, comprising:
a. at least a first layer consisting of a first plastic material and a second layer consisting of a second plastic material,
b. wherein the first plastic material has a higher temperature resistance than the second plastic material,
c. wherein the second plastic material is thermoplastic, and
d. an adhesion-promoting adhesion layer in the form of a flexible primer layer consisting of a cross-linking polymer, which bonds the first layer to the second layer by adhesion, is disposed between the first layer and the second layer.

22. The film according to claim 21, wherein the modulus of elasticity of the adhesion layer is smaller than the modulus of elasticity of the first layer and/or of the second layer.

23. The film according to claim 21, wherein the adhesion layer has a thickness of between 1 μm and 15 μm, preferably between 4 μm and 7 μm.

24. The film according to claim 23, wherein the primer layer consists of a polyurethane-based cross-linking polymer.

25. The film according to claim 21, wherein the first plastic material comprises polyamide 6.6.

26. The film according to claim 21, wherein the first layer has a thickness of at least about 10 μm and at most about 35 μm, preferably of 15 μm and at most about 25 μm.

27. The film according to claim 21, wherein the second plastic material comprises polyurethane ether, co-polyamide or co-polyterephthalate.

28. The film according to claim 21, wherein the second layer has a thickness of at least about 10 μm and at most about 35 μm, preferably of at least 15 μm and at most about 25 μm.

29. A film-coated component manufactured by compression molding, in particular for thermal and sound insulation, comprising:
an insulating layer which is coated on at least one side with a multi-layer plastic film according to claim 21, wherein the thermoplastic second layer of the multi-layer plastic film points towards the insulating layer and the multi-layer plastic film and the insulating layer are firmly bonded by melting on the second layer.

30. The film-coated compression-molded component according to claim 29, wherein the insulating layer is coated on all sides with the multi-layer plastic film.

31. The film-coated compression-molded component according to claim 29, wherein the insulating layer comprises non-woven cotton fabric, melamine resin foam or foamed polyurethane.

32. The film-coated compression-molded component according to claim 31, wherein a thermosetting resin or binder, preferably phenolic resin, melamine resin or epoxy resin, has been added to the insulating layer.

33. The film-coated compression-molded component according to claim 31, wherein the component is an engine hood lining, a dividing wall between the engine compartment and the passenger compartment, a lining for an oil pan or a lining of a transmission tunnel for a motor vehicle.

34. A method for producing a film-coated compression-molded component comprising:
a. providing a multi-layer plastic film according to claim 21,
b. providing a compression-moldable thermally and/or acoustically active insulating layer,
c. covering the insulating layer at least on one side with the multi-layer plastic film,
d. compression molding of the film-covered insulating layer, whereby the film-covered insulating layer is brought into shape, and wherein the multi-layer plastic film and the insulating layer bond in a non-detachable manner at the same time under the influence of heat by melting on the second layer of the multi-layer plastic film.

35. The method according to claim 34, wherein the provided insulating layer is at least partially impregnated with a thermosetting resin or binder.

36. The method according to claim 34, wherein the compression process lasts less than 100 seconds, preferably less than 90 second, particularly preferably less than 70 seconds.

37. The method according to claim 34, wherein the surface temperature of the molding tool used for compression molding during the compression molding process is more than 200° C., preferably more than 220° C.

38. The method according to claim 34, characterized in that the locking pressure during the compression molding process is between about 50-400 t, preferably about 100 t.

39. A use of a film-coated compression-molded component according to claim 21 for thermal and/or sound insulation in motor vehicles, in particular in the form of an engine hood lining, a dividing wall between the engine compartment and the passenger compartment, a lining for an oil pan or a lining of a transmission tunnel.

40. The use of a film-coated compression-molded component according to claim 21 in an atmosphere with a high content of water vapor and/or oil vapor and/or other aggressive substances.
